(19) United States
(12) Patent Application Publication
(10) Pub. No.: US 2025/0347041 A1
(43) Pub. Date: Nov. 13, 2025

(54) PADS MADE FROM AGRICULTURAL WASTE

(71) Applicant: Lauren Lobue, Albuquerque, NM (US)

(72) Inventor: Lauren Lobue, Albuquerque, NM (US)

(21) Appl. No.: 19/206,709

(22) Filed: May 13, 2025

Related U.S. Application Data
(60) Provisional application No. 63/646,245, filed on May 13, 2024.
(60) Provisional application No. 63/804,828, filed on May 13, 2025.

(51) Int. Cl. D04H 1/425; D04H 1/64

(52) U.S. Cl. CPC D04H 1/425; D04H 1/643

(57) ABSTRACT

The present invention relates to the field of producing eco-friendly material such as pads made from agricultural waste, such as banana crop fibers, for use in various applications such as with evaporative coolers. The invention provides methods for manufacturing durable and biodegradable cooler pads suitable for use in evaporative cooling systems, for erosion control, and agricultural applications. The pads are formed by laying out banana fibers in a predetermined configuration and applying a biodegradable bonding agent to the fibers. The bonded pads are then dried, packaged, and made ready for use in evaporative coolers. Importantly, the bonding agent employed ensures that the pads remain intact and do not disintegrate when exposed to water such as in the evaporative cooling process.

### INVENTION PRIORITY

The present embodiments claim priority to provisional patent application Ser. No. 63/804,828, filed May 13, 2025, by Lauren Lobue for “Pads Made From Agricultural Waste.” The present embodiments also claim priority to provisional patent application Ser. No. 63/646,245, filed May 13, 2024, by Lauren Lobue for “Evaporative Cooler Pads made from Banana Cellulose Fibers.”

### TECHNICAL FIELD

Embodiments are generally related to pads that can be used within evaporative coolers. More particularly, embodiments are related to eco-friendly pads made from agricultural waste, such as banana crop fibers, for use in various applications such as with evaporative coolers.

### BACKGROUND

An evaporative cooling pad, also known as a wet cooling pad or swamp cooler pad, is a device used in evaporative cooling systems. These systems are commonly used to cool air in buildings, greenhouses, poultry farms, and other spaces where air conditioning might be impractical or too costly.

The evaporative cooling pad consists of a material typically made of cellulose, aspen fiber or other absorbent materials made from synthetic material such as foams and polyester. These materials pose issues related to resource scarcity, landfill accumulation, and supply chain instability. During use, water is continuously pumped onto the pads, and as air passes through them, the water evaporates, causing the air temperature to decrease. This process works on the principle that as water evaporates, it absorbs heat from the surrounding air, thereby cooling it down.

Evaporative cooling pads are often installed in ventilation systems or air conditioning units, where hot, dry air is drawn through the pads, resulting in cooler, more humid air being circulated into the space. They are particularly effective in hot, dry climates where traditional air conditioning may be less efficient or more costly to operate. Despite the current state of the art, there is still a growing need for more sustainable and environmentally friendly alternatives to traditional cooler pads.

### SUMMARY OF EMBODIMENTS

It is ideal for the environment if agricultural waste could be repurposed. The present embodiments relate to the fields of evaporative cooling media and sustainable materials, particularly in the development of plant-based pads utilizing bio-based binders, pretreatment methodologies, or manual fiber stitching techniques. Banana fiber is an example of such waste.

Banana crop fibers come from the outer sheath formed by the leaves that grow around the trunk of the plant. Sheaths can be cut into strips and fed into a machine to extract the fiber and remove the pulp. The fiber can then be dried in the sun, bundled, and sent for processing. While banana fibers have been used in various applications such as textiles and handicrafts, their adaptation for use in evaporative cooling pads requires a creative and inventive step. This step involves recognizing the unique properties of banana fiber, such as its high absorbency and durability, and applying them to solve the specific challenges associated with evaporative cooling systems.

Banana fiber, an agricultural byproduct, presents a renewable material alternative but has historically been limited by its moisture retention, high tannin levels, and susceptibility to microbial growth. The present embodiments can address these limitations through two primary innovations. A pretreatment process can be implemented that improves the physical, microbial, and chemical profile of banana fiber. A natural construction system can be incorporated that maintains structural integrity and flow performance either through a bio-based binding agent or through manual stitching with natural thread.

Banana fiber evaporative cooling pads represent a novel invention because they utilize banana plant fibers as the primary material. Unlike conventional evaporative cooling pads made from materials like aspen fibers or synthetic foams, banana fiber pads are derived from a renewable and sustainable source that has not been previously used in this application. The use of banana fibers in the manufacture of cooling pads is environmentally friendly. Banana fiber pads are derived from a renewable and sustainable source that has not been previously used as the primary medium for evaporative cooling pads. The use of banana fiber offers unique advantages, such as higher absorbency, durability, and environmental sustainability, which distinguish these cooling pads from existing solutions in the market. Embodiments disclosed herein provide a sustainable, biodegradable, and durable alternative to traditional evaporative cooler pads, offering significant advantages in terms of environmental impact, performance, and longevity.

In accordance with feature of the inventive embodiments, a banana fiber pad can be provided that includes banana fibers taken from the stalks of banana plants that have been processed to remove impurities and prepared them for use in pad formation by being laid out into a predetermined format to ensure proper coverage and density within a matching application size and footprint.

In accordance with feature of the inventive embodiments, a biodegradable bonding agent can be applied to the laid-out banana fibers. The banana fiber pad can be formed into a predetermined format to ensure proper coverage and density within a matching application size and footprint.

In accordance with another feature of the embodiments, provided is a sustainable, high-performance alternative to conventional aspen or polyester cooling pads wherein a novel pretreatment process can be incorporated to reduce bacterial growth and tannin content and then can integrate a natural binding agent or a manual stitching method using natural thread. This can result in a structurally sound, odor-resistant, and environmentally friendly cooling medium.

### BRIEF DESCRIPTION OF DRAWINGS

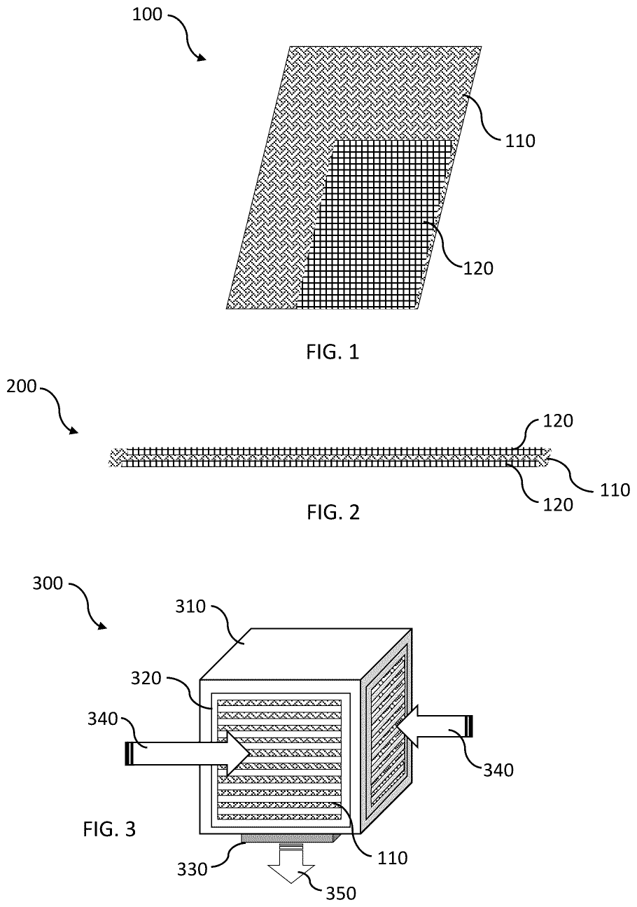

Referring to FIG. 1, illustrated is a top perspective drawings of a pad made from banana fibers;

Referring to FIG. 2, illustrated is a side perspective of a pad made from banana fibers and including a bonding agent;

Referring to FIG. 3, illustrated is an evaporative cooler with cooling pads in accordance with the embodiments installed therein;

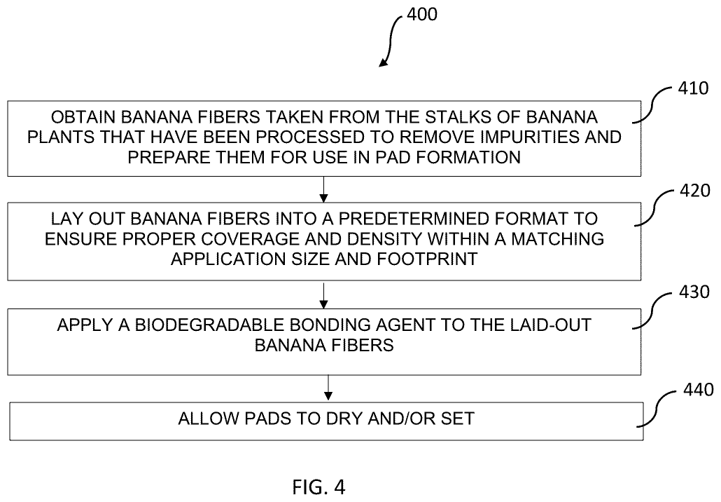

Referring to FIG. 4, illustrated is a flow diagram for a process of making a banana fiber pad;

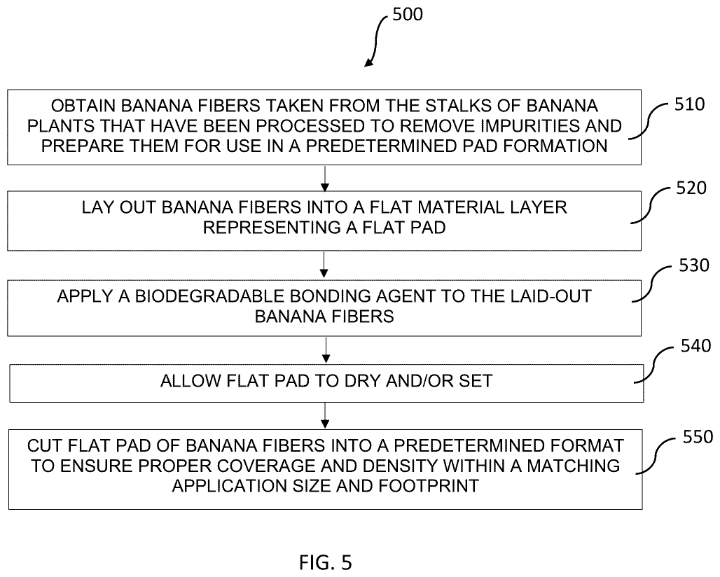

Referring to FIG. 5, illustrated is another flow diagram for a process of making a banana fiber pad; and

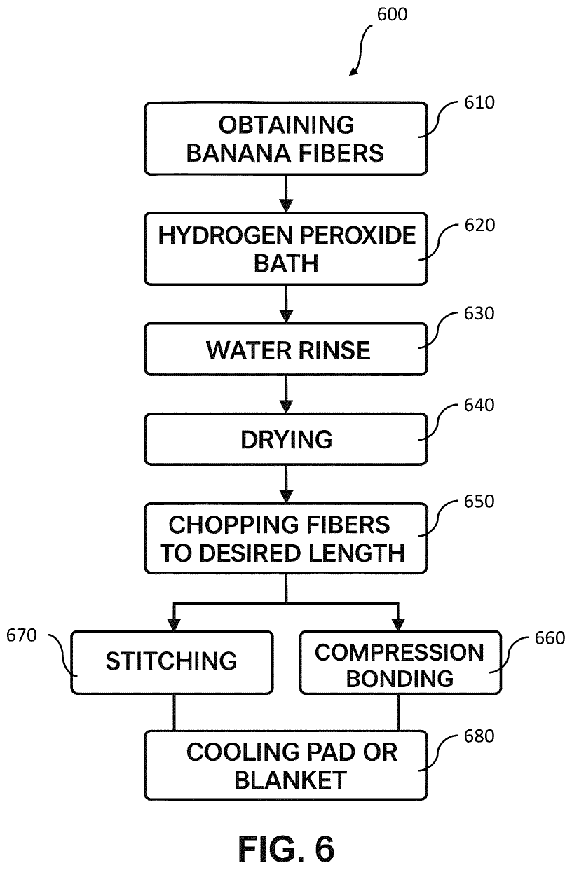

Referring to FIG. 6, illustrated is a flow diagram of pretreatment and construction process, including industrial drying and optional stitching method; and

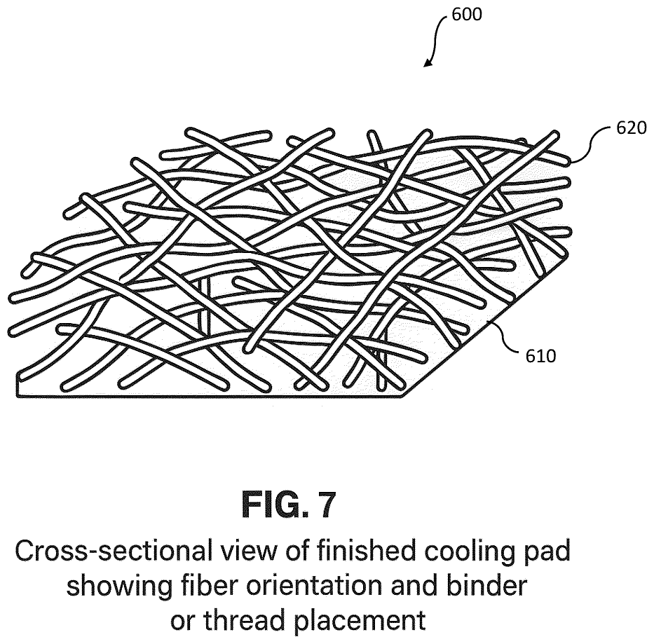

Referring to FIG. 7, illustrated is a Cross-sectional view of a finished cooling pad showing fiber orientation and binder or thread placement; and

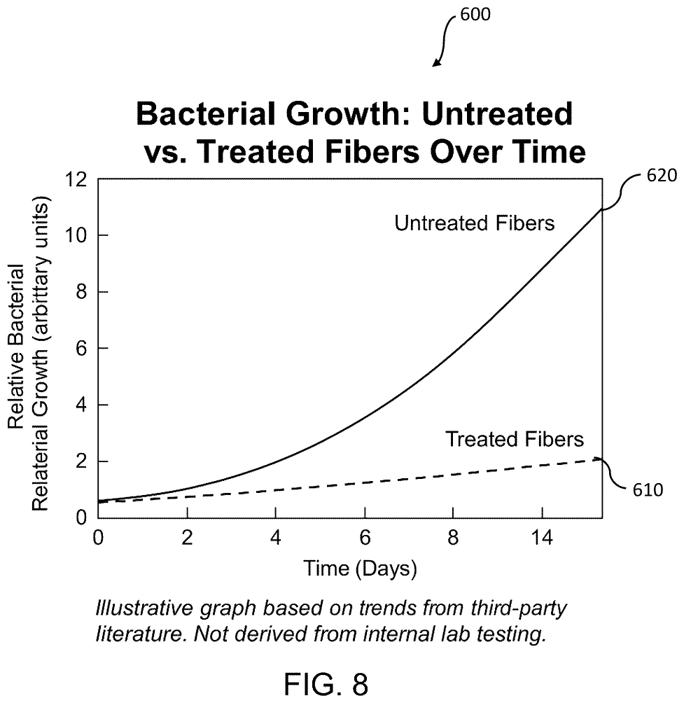

Referring to FIG. 8, illustrated is a graph of bacterial growth comparison: untreated vs. treated fibers.

### DETAILED DESCRIPTION

The present invention addresses the need for pads made from sustainable materials by introducing a novel method for manufacturing pads using agricultural waste such as banana fibers—a renewable and biodegradable material—which can be adapted for applications such as use in evaporative coolers as evaporative cooler pads. Banana fibers are mentioned as an example of a type of agricultural waste that can be repurposed as pads, such as evaporative cooler pads, but the embodiments and claims should not be interpreted as being limited to banana fibers and the only natural medium used, nor should the embodiments and claims be interpreted as a limit of pads produced herein only for use with evaporative coolers. Pads can be utilized in applications, such as a media used in landscaping and to mitigate ground surface erosion.

Referring to FIG. 1, illustrated is a perspective view 100 of a banana fiber pad 110, in accordance with an embodiment. The banana fiber pad 110 is partially shown in the illustration to be treated with a biodegradable bonding agent 120 to form a cohesive structure that maintain its integrity even when subjected to moisture during the evaporative cooling process. Importantly, the bonding agent is carefully selected to ensure compatibility with the banana fibers and to prevent disintegration or degradation upon exposure to water.

Referring to FIG. 2, illustrated is a side view 200 of the banana fiber pad 110 shown in FIG. 1. The banana fiber pad 110 is once again shown to be treated with biodegradable bonding agent 120.

Referring to FIG. 3, illustrated is perspective view 300 of an evaporative cooler 310, in accordance with an embodiment. An evaporative cooler 310 typically has at least one removable panel 320 wherein cooler padding 110 can be installed. Each removable panel has openings in the form of a grill over the surface to allow outside air 340 to be drawn into the cooler through the banana fiber pads 110. Treated air 350 can then be distributed into the environment via ducting 330 coupled to the evaporative cooler 310.

Biodegradable bonding agents that can be suitable for use in the manufacturing of evaporative cooler pads made from banana fiber can include:
1. Starch-Based Adhesives: Starch-based adhesives, derived from sources such as corn, potato, or tapioca, are widely used in various industries due to their biodegradability and adhesive properties. These adhesives can effectively bind natural fibers together and are compatible with banana fiber.
2. Soy-Based Adhesives: Soy-based adhesives are derived from soybean proteins and offer excellent bonding properties. They are biodegradable, renewable, and exhibit good adhesion to natural fibers, making them suitable for use in eco-friendly applications.
3. Gelatin: Gelatin is a protein obtained from animal collagen, but there are also alternatives made from plant sources. It has adhesive properties and can be used as a bonding agent for natural fibers like banana fiber. Gelatin-based adhesives can provide strong bonds while being biodegradable.
4. Bio-Based Polyurethane: Bio-based polyurethane adhesives are derived from renewable resources such as vegetable oils or starch. They offer good adhesion to natural fibers and can provide durable bonds. These adhesives can be formulated to be biodegradable, making them suitable for environmentally friendly applications.
5. Lignin-Based Adhesives: Lignin is a natural polymer found in plants and is a byproduct of various industries such as paper and biofuel production. Lignin-based adhesives are being explored as eco-friendly alternatives due to their renewable nature and adhesive properties. They can be used to bond natural fibers together effectively.
6. Citrus-Based Adhesives: Adhesives derived from citrus fruits, such as orange or lemon peels, offer potential as biodegradable bonding agents. These adhesives contain natural compounds that can provide adhesive properties and are environmentally friendly.

Each of these bonding agents has its unique properties and advantages, and the selection would depend on factors such as cost, availability, compatibility with banana fiber, and desired performance characteristics in the evaporative cooler pads.

The manufacturing process can involve several steps to ensure the structural integrity and performance of the pads. Referring to FIG. 4, illustrated is a flow diagram 400 of steps that can be taken for manufacturing evaporative cooling pads using banana fiber, in accordance with an embodiment. Firstly, as shown in block 410, banana fibers can be obtained from the stalks of banana plants and processed to remove impurities and prepare them for use in pad formation. Then, as shown in Block 420, these fibers can then laid out in a predetermined form or configuration (i.e., format), ensuring proper coverage and density within a matching application size and footprint (e.g., evaporative cooler panel to achieve optimal cooling efficiency, landscaping/ground erosion control application). Next, as shown in Block 430, a biodegradable bonding agent can be applied to the laid-out fibers. The bonding agent serves to bind the fibers together, forming a cohesive structure that maintains its integrity even when subjected to moisture during the evaporative cooling process. The bonding agent can be carefully selected to ensure compatibility with the banana fibers and to prevent disintegration or degradation upon exposure to water. Once the bonding agent is applied, the pads are allowed to dry or set, as shown in Block 440, ensuring that the fibers and the bonding agent form a strong and durable composite material. After drying, the pads can be inspected for quality and consistency before being packaged for shipment to end-users.

Upon receiving the pads, consumers can, for example, easily install them in their evaporative coolers, where they effectively absorb water and facilitate the evaporation process, thereby providing efficient and eco-friendly cooling.

Referring to FIG. 5, illustrated is another flow diagram of a method of manufacturing a banana fiber pad, in accordance with an embodiment. Referring to Block 510, banana fibers taken from the stalks of banana plants that have been processed to remove impurities can be obtained and prepared for use in creating a predetermined pad formation. As shown in Block 520, banana fibers can be laid out into a flat material layer representing a flat pad. Then, as show Block 530, a biodegradable bonding agent can be applied to the laid-out banana fibers. As shown in Block 540, the flat pad can then be allowed to dry and/or set. Finally, as shown in Block 550, the flat pad of banana fibers can be cut into a predetermined format to ensure proper coverage and density within a matching application size and footprint.

Referring to FIG. 6, illustrated is yet another flow diagram 600 providing alternative steps for fiber processing, in accordance with an embodiment. As shown in Block 610, fibers are obtained for processing. The fibers can then be soaked in a hydrogen peroxide bath, as show in Block 620. Afterwards, the fibers can be rinsed in/with water as shown in Block 630. As shown in Block 640, the fibers are then dried. Then as shown in Block 650, the fivers can be chopped into a desired length or size. Then the fibers can be assembled together by either using a bonding agent as shown in Block 660, or by stitching the fibers as shown in Block 670. Once assembled into a sheet, the fibers now in sheet form can be formatted (e.g., cut, shaped) into an appropriate size needed for its application (e.g., animal bedding, evaporative cooler pad, landscaping, erosion control), as shown in Block 680.

Further manufacturing processes that can be utilized to produce pads from banana fibers can also include the following detailed steps:

### Raw Material Preparation:

Obtain banana fibers from banana plant stalks. This can involve harvesting mature banana plants, removing the outer layers, and extracting the fibers.
Clean the banana fibers to remove impurities, dirt, and other contaminants. This can be achieved through washing and drying processes.

### Fiber Processing:

Optionally, the banana fibers can undergo additional processing steps such as cutting or shredding to achieve uniform length and thickness.
The processed fibers are then arranged in a predetermined form or configuration. This can involve layering the fibers to achieve the desired thickness and density for the cooler pads.

### Bonding Agent Application:

Prepare the chosen biodegradable bonding agent according to manufacturer guidelines or formulation protocols.
Apply the bonding agent evenly over the arranged banana fibers. This can be done using techniques such as spraying, brushing, or dipping.
Ensure thorough coverage of the fibers with the bonding agent to promote strong adhesion and cohesion in the final pads.

### Drying and Curing:

Allow the bonding agent-coated banana fiber pads to dry and cure. This can be achieved through natural air drying or using controlled drying equipment.
Ensure adequate drying time to allow the bonding agent to fully set and cure, forming a strong and durable bond between the fibers.
Monitor temperature and humidity conditions during the drying process to prevent over-drying or moisture retention.

### Quality Control and Inspection:

Inspect the dried cooler pads for quality assurance. This can involve visual inspection for uniformity, integrity, and absence of defects.
Perform physical tests, such as tensile strength and flexibility tests, to assess the mechanical properties of the pads.
Reject any pads that do not meet quality standards and reprocess or discard them accordingly.

### Packaging and Storage:

Once the cooler pads pass quality control checks, package them in suitable packaging materials for protection during storage and transportation.
Label the packages with relevant product information, including material composition, dimensions, and usage instructions.
Store the packaged cooler pads in a dry and controlled environment to prevent moisture absorption or degradation before use.

### Distribution and Use:

Distribute the packaged cooler pads to retailers, wholesalers, or end-users as per distribution channels.
Provide instructions for proper installation and use of the cooler pads in evaporative cooling systems.
Monitor customer feedback and satisfaction to identify any potential improvements or adjustments to the manufacturing process.

Other pretreatment and construction processes, including industrial drying and optional stitching methods, can include the following:

### 1. Pretreatment Process of Banana Fiber

The banana fiber can be undergo a proprietary multi-stage pretreatment process prior to integration into the cooling pad matrix:
   a. Initial Rinsing and Sorting:
      Raw banana fibers can be mechanically separated and rinsed with clean water to remove surface debris.
      Fibers can be sorted to remove pieces with excessive pith or contaminants.
   b. Tannin Reduction Soak:
      Fibers can be soaked in a mild acidic or enzymatic solution to leach excess tannins.
      pH-adjusted water (citric acid or vinegar bath) or natural enzymatic agents (e.g., pectinase) can be used.
      Soak duration ranges from 6 to 24 hours depending on fiber density.
   c. Microbial Stabilization:
      A probiotic bacterial rinse or enzyme wash can be applied to inhibit microbial growth during storage and use.
      Alternatively, UV or heat sterilization may be applied.
   d. Industrial Drying:
      Due to high water retention in banana fiber, drying can be performed using an industrial dryer capable of consistent heat and airflow.
      This step can ensure rapid moisture reduction and uniform drying, targeting a moisture content below 12%.

Another manufacturing processes that can be utilized to produce evaporative cooler pads from banana fibers can also include the following detailed steps:

### 2. Construction Methods for the Cooling Pad

Two distinct methods may be used to form the final pad:
   a. Natural Binding Agent Application
      Binder Composition: The binding agent can be derived from naturally sourced materials and is free of synthetic polymers.
      Binder Application: The binder can be sprayed or coated onto layered banana fibers, then pressed and allowed to cure at 30-50° C.
      Curing Result: Creates a semi-rigid matrix that maintains water absorption, air permeability, and dimensional stability.
   b. Manual Stitching with Natural Thread
      An alternative method involves stitching pretreated banana fibers together using natural thread such as jute, cotton or banana.
      This method allows for flexibility in shape and assembly, particularly for large-format or agricultural cooling pad applications.
      The resulting product retains biodegradability and sustainability goals while enabling modular production techniques.

Referring to FIG. 7, illustrated is a Cross-sectional view and example of a finished cooling pad 700 showing fiber 710 orientation and binder or thread placement 720.

Referring to FIG. 8, illustrated is a graph 800 of bacterial growth comparison: untreated 820 vs. treated 810 fibers. As can be seen from the graph, treated fibers 810 experience less bacterial growth than untreated fibers 820.

By following the detailed manufacturing processes described above, it is possible to produce high-quality pads from banana fibers that meet performance, sustainability, and durability requirements.

Banana fiber used as evaporative cooling pads offer distinct advantages over existing cooling pad technologies, setting them apart as a unique and valuable innovation. These advantages include improved absorbency, durability, energy efficiency, and environmental sustainability compared to conventional materials used in cooling pads. By emphasizing the distinctive features and benefits of banana fiber evaporative cooling pads, we can establish its unique value proposition and the competitive advantage it offers in the marketplace.

The invention of banana fiber evaporative cooling pads is novel, non-obvious, and distinct due to its use of a previously unexplored material for this application, the creative combination of elements to address specific challenges, and the unique advantages it offers over existing technologies.

Introducing a new evaporative cooling pad made from banana fibers presents several significant advantages and solves several problems compared to traditional aspen fiber cooling pads:

Utilizing renewable banana fiber as a primary material, reduces reliance on non-renewable resources. Banana fiber cooling pads contribute to environmental sustainability by utilizing banana crop waste. Banana fibers are sourced from crop waste, and they can provide a solution that reduces reliance on traditional materials like aspen fibers, which require the cutting down of trees. This approach helps to conserve forests and reduces the environmental impact associated with deforestation.

The pads and bonding agent can be biodegradable, minimizing environmental impact and promoting eco-friendly practices.

Banana fibers are highly absorbent and durable, increasing the efficiency of, fro example, the cooling pads. This means they can absorb and retain more water, enhancing the cooling effect and reducing the amount of water needed for evaporative cooler operation. Additionally, banana fibers can have a longer lifespan than traditional materials, reducing the frequency of replacement and overall resource consumption. Banana fiber pads are so absorbent that their use can require less material to provide equal or better cooling than pads that are currently in use.

Recycling crop waste material like banana fibers for pads used in, inter alia, applications such as evaporative coolers, for landscaping, for control soil erosion, can lead to cost savings compared to using traditional materials. Since banana fibers are a byproduct of existing agricultural processes, they can be more readily available and less expensive to procure than materials sourced from trees.

Utilizing banana fibers for the creation of pads can have positive social implications by creating opportunities for farmers and communities involved in banana cultivation. It can provide an additional source of income and contribute to the utilization of agricultural waste, promoting economic and social development in banana-producing regions.

Banana fibers, being highly absorbent, can enhance the cooling efficiency of the pads compared to traditional materials. This improvement in performance can lead to more effective cooling in hot and dry climates, providing better comfort and productivity for individuals in various settings, including residential, commercial, and industrial spaces. The bonding agent ensures that the pads remain intact and functional even when exposed to water, prolonging their lifespan and effectiveness in, for example, evaporative cooling systems.

Major and Immediate Applications: The banana fiber pad can be used as a replacement for traditional evaporative cooling pads in various industries such as data centers, commercial buildings, agricultural facilities, and industrial processes. Its primary function is to provide efficient and sustainable cooling while reducing energy consumption and environmental impact.

In addition to its immediate applications, the banana fiber pad may be used in other industries or sectors where pads have utility. For example, it could be adapted for use in residential air conditioning systems, outdoor events, and recreational spaces or portable cooling units for emergency relief efforts. The concept of this pad serving as a base for new pads that collect carbon in Direct Air Capture (DAC) Facilities can also be explored as a use of banana fiber. Pads can be used to control surface erosion. Pads can be used in landscaping to promote moisture retention in underlying soil. Pads can be used for animal bedding.

Overall, the embodiments describing use of a banana fiber pad has broad potential applications and may attract interest from a range of companies, organizations, and individuals looking to leverage its benefits for sustainable cooling solutions.

Pads made from banana fibers are ideal for because they possess certain properties that may contribute to reducing the growth of harmful organisms, although they may not provide complete protection on their own. Here are some ways in which banana fibers could potentially inhibit the growth of harmful organisms:
1. Antimicrobial Properties: Some natural fibers, including banana fibers, contain antimicrobial compounds that can inhibit the growth of bacteria, fungi, and other microorganisms. These compounds may help create an environment less conducive to microbial growth.
2. Moisture Regulation: Banana fibers have moisture-wicking properties, which can help keep surfaces dry by absorbing excess moisture. Since many harmful organisms thrive in moist environments, maintaining dry conditions can hinder their growth and proliferation.
3. Biodegradability: Banana fibers are biodegradable, meaning they break down naturally over time. This property can prevent the accumulation of organic matter, which could serve as a breeding ground for harmful organisms.
4. Chemical Composition: The chemical composition of banana fibers, including the presence of lignin, cellulose, and other compounds, may contribute to their resistance to microbial degradation.

While banana fibers may offer some degree of protection against harmful organisms, it's essential to note that their effectiveness may vary depending on factors such as fiber treatment, environmental conditions, and the specific types of organisms involved. Additionally, for applications where microbial resistance is critical, supplementary measures such as antimicrobial treatments or coatings may be necessary to enhance protection.

1. A biodegradable pad, comprising:
cellulose fibers derived from agricultural waste, wherein the fibers are banana fibers obtained from the outer sheath of banana plants;
the banana fibers being processed to remove impurities and chopped to a predetermined size;
the fibers arranged into a predetermined format corresponding to an application footprint; and
a biodegradable bonding agent applied to the arranged fibers to bind them into a cohesive, moisture-resistant pad structure;
wherein the pad is configured for use in at least one of the following applications: evaporative cooling, landscaping moisture retention, or surface erosion control.

2. The pad of claim 1, wherein the banana fibers are laid in a crosshatched or layered pattern to improve fluid wicking and structural strength.

3. The pad of claim 1, wherein the bonding agent is applied in liquid form and cured at ambient or low heat conditions to avoid degradation of fiber properties.

4. The pad of claim 1, wherein the pad is odor-resistant and exhibits reduced microbial growth due to pretreatment of the banana fibers.

5. The pad of claim 1, wherein the pretreatment includes chemical treatment with hydrogen peroxide to reduce tannin content.

6. The pad of claim 1, wherein the pad is cut into a honeycomb, corrugated, or flat panel format.

7. The pad of claim 1, wherein the fibers are sourced from post-harvest banana waste, enhancing sustainability and cost efficiency.

8. A biodegradable pad, comprising:
cellulose fibers derived from banana plant sheaths that have been processed, rinsed, dried, and chopped into desired lengths;
the fibers arranged into a pad format with a predetermined density and shape; and
the fibers bound together using a manual stitching technique with natural thread to form a structurally sound pad;
wherein the pad is adapted for use as at least one of an evaporative cooler medium, landscaping substrate, or erosion control blanket.

9. The pad of claim 8, wherein the stitching is performed using jute or cotton thread to maintain biodegradability.

10. The pad of claim 8, wherein the manually stitched pad includes reinforcement stitching at the edges to prevent delamination.

11. The pad of claim 8, wherein the stitched pad exhibits compressibility and springback suitable for cushioning applications in addition to cooling.

12. A method of manufacturing a biodegradable pad from banana fibers, comprising the steps of:
obtaining banana fibers from the stalks of banana plants;
treating the fibers by soaking in a hydrogen peroxide bath, rinsing with water, and drying;
chopping the fibers into predetermined lengths;
arranging the fibers into a flat layer to form a pad shape;
binding the arranged fibers using either a biodegradable bonding agent or a manual stitching technique with natural thread; and
cutting the resulting fiber pad into an application-specific format;
wherein the resulting pad is biodegradable and suitable for use in evaporative cooling, erosion control, or moisture retention landscaping.

13. The method of claim 12, wherein the chopped fibers are sized between 5 mm and 25 mm in length.

14. The method of claim 12, wherein the hydrogen peroxide concentration used in the pretreatment step ranges from 1% to 5%.

15. The method of claim 12, further comprising the step of sun-drying the fibers after rinsing.

16. The method of claim 12, wherein the binding agent is sprayed, brushed, or rolled onto the fiber mat prior to drying.

17. The method of claim 12, wherein the pad is pressed to a thickness of 5 mm to 50 mm after the bonding step.

18. The method of claim 12, wherein the pad is manufactured in modular segments for use in scalable evaporative cooling systems.
